(19) United States
(12) Patent Application Publication
(10) Pub. No.: US 2025/0310131 A1
(43) Pub. Date: Oct. 2, 2025

(54) OPTICAL PHYSICALLY UNCLONABLE FUNCTIONS

(71) Applicant: British Telecommunications Public Limited Company, London (GB)

(72) Inventor: Catherine WHITE, London (GB)

(21) Appl. No.: 18/863,955

(22) PCT Filed: Apr. 6, 2023
(86) PCT No.: PCT/EP2023/059240

§ 371 Date: Nov. 7, 2024

(30) Foreign Application Priority Data
May 12, 2022 (GB) 2206965.2
Jul. 13, 2022 (EP) 22184801.3

(51) Int. Cl. H04L 9/32

(52) U.S. Cl. CPC H04L 9/3278

(57) ABSTRACT

A physically unclonable function (PUF) configured to receive a challenge signal and produce a response signal dependent on the challenge signal in response thereto; wherein: the PUF comprises a photonic crystal structure of plural dimensionality which is configured to: be illuminated by an optical input signal which is, or is derived from, the challenge signal; and responsive thereto, produce an optical output signal dependent on the optical input signal's interaction with the photonic crystal structure, wherein the response signal is, or is derived from, the optical output signal.

### FIELD

The present disclosure relates to physically unclonable functions (PUFs), their use and manufacture.

More specifically, aspects relate to PUFs, photonic integrated circuits (PICs) comprising such PUFs, optical networks comprising a plurality of such PUFs, methods of validating routes taken by optical signals through such optical networks, methods of manufacturing such PUFs, methods of producing a plurality of such PUFs which are substantially identical, authentication systems comprising such a plurality of substantially identical PUFs, authentication methods using such authentication systems, methods of using such PUFs, authentication methods comprising such methods, data processing systems configured to perform such methods, computer programs comprising instructions which, when the programs are executed by computers, cause the computers to carry out such methods, computer-readable data carriers having stored thereon such computer programs, and data carrier signals carrying such computer programs.

### BACKGROUND

A PUF is a device configured to receive a defined input or challenge signal and provide a physically defined response thereto which serves as a unique identifier. PUFs can have a role in security tasks such as authentication. Increased security can be provided by stronger PUFs, i.e. PUFs which are more difficult to clone or model.

As communication networks increasingly make use of optical fibre technology, optical PUFs have become more desirable for ensuring the security of optical networks, as they can be highly integrated into optical circuits and devices, providing a strong binding of the PUF to a physical optical network element.

What is needed are improved optical PUFs, as well as methods of manufacturing and using them.

### SUMMARY

According to a first aspect, there is provided a PUF configured to receive a challenge signal and produce a response signal dependent on the challenge signal in response thereto; wherein:
the PUF comprises a photonic crystal structure of plural dimensionality which is configured to:
   be illuminated by an optical input signal which is, or is derived from, the challenge signal; and
   responsive thereto, produce an optical output signal dependent on the optical input signal's interaction with the photonic crystal structure, wherein the response signal is, or is derived from, the optical output signal.

The photonic crystal structure can comprise one or more structural features introduced to break a translational symmetry of one or more crystalline lattices comprised in the photonic crystal structure, the PUF being arranged such that the optical input signal illuminates the photonic crystal structure from one or more angles configured so that the optical input signal's interaction with the photonic crystal structure to produce the optical output signal comprises interaction with at least one of the one or more structural features.

The PUF can further comprise one or more functional perimeter components, the photonic crystal structure being positioned within a perimeter formed by the one or more functional perimeter components.

The photonic crystal structure can comprise a plurality of photonic crystalline grains optically coupled together. The PUF can further comprise one or more functional intervening components positioned between two or more of the plurality of photonic crystalline grains. The one or more functional intervening components can comprise one or more optical waveguides configured to optically couple the plurality of photonic crystalline grains together. The PUF can comprise two or more optical waveguides configured to optically couple the plurality of photonic crystalline grains together, wherein at least two of those optical waveguides can be directly optically coupled to one another.

The PUF can comprise a plurality of optical paths of different optical path lengths, into which the optical input signal is input, the plurality of optical paths converging to produce the optical output signal as a superposition.

The photonic crystal structure can comprise one or more two-dimensional photonic crystalline grains.

The PUF can further comprise a component configured to be physically modified in response to all or part of the challenge signal or an auxiliary signal received with the challenge signal in such a way that the optical output signal depends thereon, by modifying one or both of the optical input signal and the optical input signal's interaction with the photonic crystal structure.

The PUF can further comprise an optical fibre in which the photonic crystal structure is located. The optical fibre can comprise a solid core in which the photonic crystal structure is inscribed. Alternatively, the optical fibre can comprise a hollow core in which the photonic crystal structure is contained. The PUF can further comprise an additional optical fibre optically coupled, by a beam splitter, to the optical fibre in which the photonic crystal structure is located; wherein a lattice of the photonic crystal structure is angled with respect to a longitudinal axis of the optical fibre in which it is located such that light scattered off-axis by the photonic crystal structure is coupled into the additional optical fibre, the optical output signal being composed, at least in part, of said light scattered off-axis by the photonic crystal structure and coupled into the additional optical fibre.

According to a second aspect, there is provided a photonic integrated circuit, (PIC), comprising the PUF of the first aspect.

According to a third aspect, there is provided an optical network comprising a plurality of the PUFs of the first aspect distributed in series along a route and configured such that:
an initial PUF of the plurality, on receiving an initial challenge signal, issues a corresponding response signal as a challenge signal to an immediately succeeding PUF of the plurality;
a final PUF of the plurality, on receiving a response signal from an immediately preceding PUF of the plurality, takes that response signal as a challenge signal and issues a corresponding final response signal; and
any PUFs of the plurality intermediate the initial and final PUFs, on receiving a respective response signal from a respective immediately preceding PUF of the plurality, take that respective response signal as a respective challenge signal and issue a corresponding respective response signal as a respective challenge signal to a respective immediately succeeding PUF of the plurality.

According to a fourth aspect, there is provided a method of validating the route taken by an optical signal through the optical network of the third aspect, the method comprising:
configuring the optical signal to comprise the initial challenge signal;
transmitting the optical signal along the route;
receiving a signal comprising the final response signal; and
confirming that the final response signal corresponds to one or both of:
   the initial challenge signal in a stored challenge-response pair, ‘CRP’, list; and
   a final response signal issued by a clone of the route in response to the initial challenge signal being transmitted thereon.

According to a fifth aspect, there is provided a method of manufacturing the PUF of the first aspect, wherein the photonic crystal structure comprises one or more structural features introduced to break a translational symmetry of one or more crystalline lattices comprised in the photonic crystal structure, the PUF being arranged such that the optical input signal illuminates the photonic crystal structure from one or more angles configured so that the optical input signal's interaction with the photonic crystal structure to produce the optical output signal comprises interaction with at least one of the one or more structural features, the method comprising creating the one or more structural features.

The method can comprise:
placing a mask on a substrate;
depositing material over the mask; and
destroying the mask.

Creating the one or more structural features can comprise sputtering a stochastic pattern onto the photonic crystal structure.

The mask can define the stochastic pattern.

The method can further comprise designing the mask using a lattice generator algorithm which takes one or more stochastic parameters as input.

According to a sixth aspect, there is provided a PUF manufactured according to the method of the fifth aspect.

According to a seventh aspect, there is provided a method of producing a plurality of substantially identical PUFs by performing the method of the fifth aspect, wherein the steps of placing the mask on a substrate and depositing material over the mask are repeated for a plurality of substrates to produce a corresponding plurality of substantially identical PUFs before the step of destroying the mask is performed.

According to an eight aspect, there is provided a method of producing a plurality of substantially identical PUFs by performing the method of the fifth aspect, then dividing the photonic crystal structure to transect the one or more structural features.

According to a ninth aspect, there is provided an authentication system comprising the plurality of substantially identical PUFs manufactured according to the method of either of the seventh or eighth aspects.

According to tenth aspect, there is provided an authentication method using the authentication system of the ninth aspect, the method comprising:
obtaining a benchmark response to a common challenge using a PUF of the plurality of substantially identical PUFs known to be held by a trusted authority;
sending a request for a comparable response to a party claiming to hold a further PUF of the plurality of substantially identical PUFs;
receiving the comparable response; and
determining whether the party claiming to hold the further PUF is authenticated based on a comparison between the benchmark response and the comparable response.

According to an eleventh aspect, there is provided a method of using the PUF of any of the first aspect, or the PIC of the second aspect, the method comprising:
receiving the challenge signal; and
producing the response signal.

According to a twelfth aspect, there is provided an authentication method comprising:
generating a list of challenge-response pairs, ‘CRPs’, by performing the method of the eleventh aspect repeatedly using different challenge signals and recording the corresponding response signals; and
securely communicating a different subset of the CRPs to each of a plurality of challengers so that each challenger of the plurality can confirm that a correspondent is in possession of the PUF by transmitting a challenge signal selected from their subset of the CRPs to the correspondent and confirming that a response signal received from the correspondent matches the response signal corresponding to the selected challenge signal.

According to a thirteenth aspect, there is provided an authentication method comprising:
receiving a message comprising a challenge signal and a predicted response signal;
performing the method of the eleventh aspect; and
determining whether an originator of the message is authenticated based on a comparison between the response signal produced according to the method of the eleventh aspect and the predicted response signal.

According to a fourteenth aspect, there is provided an authentication method comprising:
obtaining a message comprising a challenge signal;
performing the method of the eleventh aspect;
generating a message authentication code based on the response signal; and
sending the message back to its originator together with the message authentication code so that the originator can authenticate that an entity performing the method possesses the PUF.

The initial challenge signal of the fourth aspect;
the common challenge of the tenth aspect;
the challenge signal of the eleventh, thirteenth or fourteenth aspects; or
the selected challenge signal of the twelfth aspect; can be distinguished from other challenges, at least in part, by one or both of optical phase variation and optical pulse profile.

According to a fifteenth aspect, there is provided a data processing system configured to perform the method of either of the fourth or tenth aspects.

According to a sixteenth aspect, there is provided a computer program comprising instructions which, when the program is executed by a computer, cause the computer to carry out the method of either of the fourth or tenth aspects.

According to a seventeenth aspect, there is provided a computer-readable data carrier having stored thereon the computer program of the sixteenth aspect.

According to an eighteenth aspect, there is provided a data carrier signal carrying the computer program of the sixteenth aspect.

### BRIEF DESCRIPTION OF THE FIGURES

Aspects of the present disclosure will now be described by way of example with reference to the accompanying figures. In the figures:

FIG. 1A is a schematic illustration of an example PUF;

FIG. 1B is a schematic illustration of an example photonic crystal structure;

FIG. 2 is a schematic illustration of another example PUF;

FIG. 3 is a schematic illustration of an example solid core optical fibre PUF;

FIG. 4 is a schematic illustration of an example hollow core optical fibre PUF;

FIG. 5 is a schematic illustration of an example optical fibre PUF;

FIG. 6 is a schematic illustration of an example optical network;

FIG. 7 is a flowchart of an example validation method;

FIG. 8 is a flowchart of an example method of manufacture;

FIG. 9 is a flowchart of another example method of manufacture;

FIG. 10 is a flowchart of an example authentication method;

FIG. 11 is a flowchart of another example authentication method;

FIG. 12 is a flowchart of another example authentication method;

FIG. 13 is a flowchart of another example authentication method;

FIG. 14 is a schematic illustration of an example authentication system; and

FIG. 15 is a schematic illustration of an example data processing system.

### DETAILED DESCRIPTION

The following description is presented to enable any person skilled in the art to make and use the system and/or perform the method of the invention, and is provided in the context of a particular application. Various modifications to the disclosed embodiments will be readily apparent to those skilled in the art.

The terms “top”, “bottom”, “side”, “front”, “back”, “forward”, “rear”, “clockwise”, “anticlockwise” and other terms describing the orientation of features are not intended to be limiting and, where used, are purely included in order to facilitate the description of the relative location of these features in the context of the accompanying drawings. In use, or during storage, the features may be disposed in other orientations.

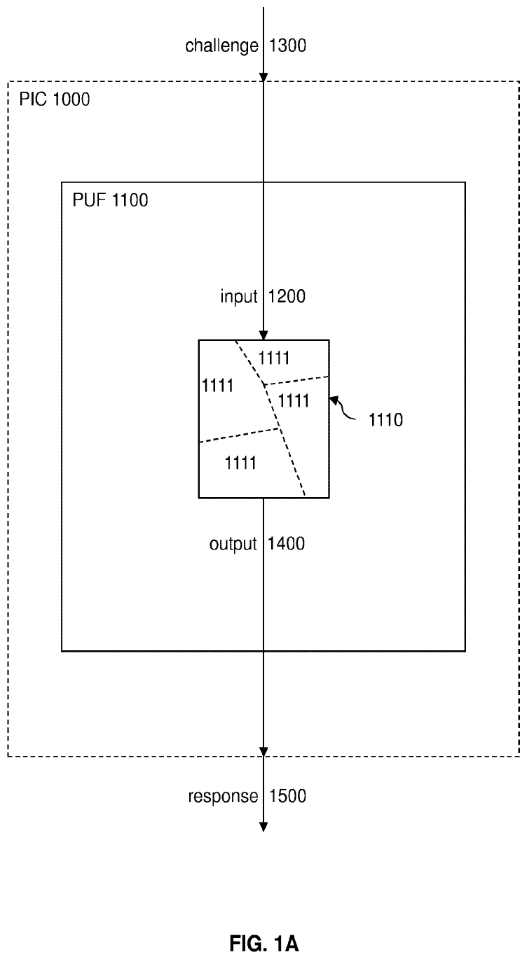

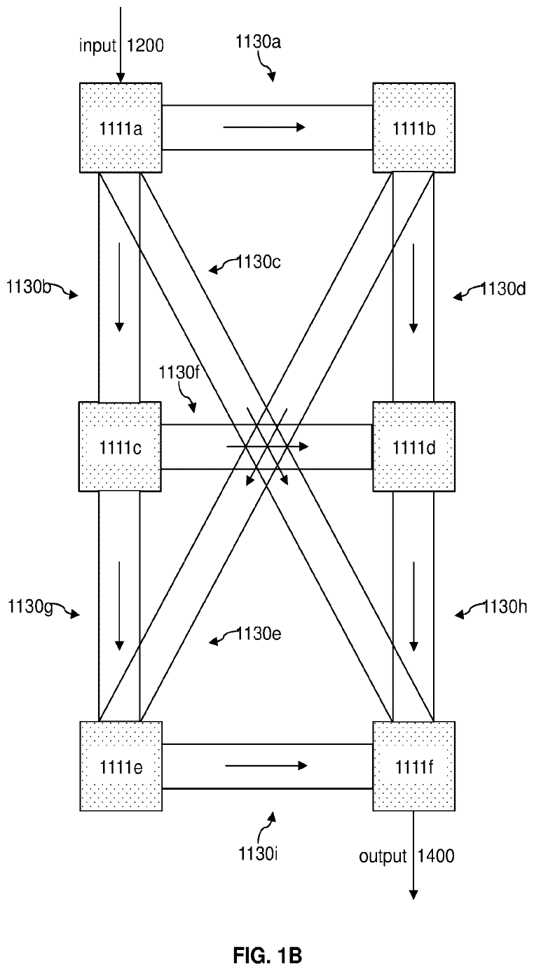

A type of PUF is proposed herein, configured to receive a challenge signal and produce a response signal dependent on the challenge signal in response thereto. As schematically illustrated in FIG. 1A, the PUF 1100 comprises a photonic crystal structure 1110 which is configured to be illuminated by an optical input signal 1200 which is, or is derived from, the challenge signal 1300. An optical output signal 1400 is produced by the PUF dependent on the optical input signal 1200′s interaction with the photonic crystal structure 1110. The response signal 1500 is, or is derived from, the optical output signal 1400. Such a PUF can be integrated into a communication network. If the communication network is optical then no electro-optic signal conversion is required.

The optical input signal 1200 can be a coherent pulse, with well-defined phase and frequency profile. It can for example originate from a laser diode or other source, such as a single photon source. Alternatively, two or more sources may provide the optical input signal 1200, which can be locked to each other, i.e. with each source emitting light which is coherent with respect to the other source(s). For example, coherent light from the same laser can be split along two or more paths (e.g. using a beamsplitter), then directed towards different apertures from which it is incident onto the photonic crystal structure. Optionally each path can be subject to different optical modulation, e.g. temporal pulse-shaping, phase modulation or spectral filtering (which may also be time variant).

In some implementations the optical input signal 1200 can be optically (spatially) expanded (e.g. using a lens), polarised, and/or collimated before it is incident onto the photonic crystal structure 1110. Polarising the light aids uniformity and reproducibility of results, as the behaviour of the PUF may be polarisation sensitive and easier to characterise for a single polarisation. Collimation can similarly improve reproducibility.

In some implementations a path of the optical signal through the PUF 1100 can comprise an input polariser in advance of the photonic crystal structure 1110 and an output polariser, which is not aligned with the input polariser, following the photonic structure 1110. In this way the optical output signal will depend in part on polarisation dependent properties such as the birefringence of the photonic crystal structure. Birefringence can thus be used as an additional variable in PUF design, leading to stronger PUFs.

In some scenarios there is a risk that environmental conditions which result in physical modification of the PUF (e.g. via thermal expansion) and/or disturbances to the challenge and/or optical input signals (e.g. small phase or polarisation changes or chromatic dispersion) may change the response of the PUF 1100 to the challenge, increasing the variability error between the expected response and the response provided by the PUF 1100. The variability error tends to be worse the more complex the PUF, therefore it can be a particular issue for the types of multi-dimensional photonic crystal structure based PUFs described herein, especially those which make use of multiple light propagation properties (polarisation, frequency etc.) for their intentional challenge-response variability. To mitigate against this issue, mechanisms for thermal stabilisation of the device, for example by Peltier cooling, and/or electromagnetic shielding, and/or polarisation and/or collimation may be implemented on the PUF 1100. Alternatively or additionally, the PUF may comprise sensors to enable measurement of parameters which could unintentionally vary the response such as temperature, polarisation, phase or changes in optical path length (e.g. as measured by interferometry). The measurement results can then be used by the PUF to actively and dynamically self-calibrate, if components are provided for doing so. Alternatively or additionally, the measurement results can be taken into account in the determination of whether the response signal is as expected.

The optical output signal 1400 can be measured by one or more detectors, which can for example be optical detector arrays, such as photodiode arrays, either comprised in the PUF or in one or more other devices the PUF communicates the optical output signal to. If the optical output signal is digitised to produce the response signal 1500 then the digitisation can be of the optical output signal intensity as a function of time since the challenge signal 1300 is sent, allowing the unique output (determined by factors such as interference, chromatic dispersion and latency) of the PUF to be properly characterised.

The schematic illustration of FIG. 1A shows the optical output signal 1400 exiting the photonic crystal structure 1110 at a location diametrically opposed to the location the optical input signal 1200 enters the photonic crystal structure 1110, with no other components of the PUF 1100 changing the optical signal's course, such that the PUF 1100 is shown as entirely transmissive. In some implementations however the photonic crystal structure 1110 and/or other components of the PUF 1100 (and/or a PIC 1000 in which it is comprised) may change the course of the optical signal and/or split and/or recombine it. In this way, the PUF 1100 can be partially transmissive and partially reflective, or entirely reflective.

A photonic crystal is an optical medium comprising a periodically repeating pattern of elements or motifs configured to scatter light, where the repetition periods are of the order of optical wavelengths, for example 20 nm to 3000 nm, or more commonly 200 nm to 1500 nm, for example 800 nm may be a suitable choice to work with typical optical fibre telecommunications (of wavelength 1600 nm) while 400 nm may be more appropriate to work with typical free space optical communications (of wavelength 800 nm). The repetition periods are generally on the scale of equal or less than the wavelength of the light they are intended to work with (whether visible, ultraviolet or infrared). The motifs can for example be micro-dots, micro-rings, micro-polygons or another structured shape, which can be point-like, such as micro-snowflakes, or have a different shape which need not have any inherent symmetries.

The photonic crystal structure proposed is of plural dimensionality. That is, the photonic crystal structure can comprise one or more photonic crystalline grains or regions, each characterised by a periodic lattice extending in two or three dimensions. (Grain/region size is generally larger than the wavelength of the optical input signal, for example of order ten times or larger than the longest wavelength present in the optical input signal, e.g. 2 μm to 500 μm.) An example of a photonic crystal structure comprising a plurality of three dimensional photonic crystalline grains or regions is a natural or artificial opal.

Alternatively, the photonic crystal structure can comprise two or more one dimensional periodic gratings, optically coupled so as to form a structure having a logical dimensionality of two or more, in the sense that the connectivity of the structure can be described by a planar or higher dimensional graph. For example, such one-dimensional gratings could be layered on top of or adjacent one another, or optically coupled by waveguides and/or other optical components. In general, the photonic crystal structure can have a higher logical dimensionality than the dimensionality of each of a plurality of periodic arrays (e.g. lattices or gratings) it comprises, provided those arrays are optically coupled to one another in a suitable way. For example, waveguides could couple the arrays to one another in such a way that the relationships between optical parameters such as phase, polarisation and frequency of light at different positions on the output interface of one array are preserved at corresponding positions on the input interface of the next. (This could for example be achieved by two adjacent arrays on the optical input signal's path through the PUF being coupled by a plurality of waveguides all of the same length, which could suitably be an integer multiple of the optical input signal wavelength where a monochromatic optical input signal is used.) Alternatively, those relationships could be transformed in a regular way, for example the phase could be advanced by an amount which depends on distance along the respective interface. (This could for example be achieved by two adjacent arrays on the optical input signal's path through the PUF being coupled by a plurality of waveguides which increase in length when considered sequentially along the respective interface.) In some implementations, coupling waveguides may overlap each other, for example on a multi-layered PIC. Overlapping waveguides could be separated by an optically isolating material, or could be intentionally optically coupled to one another. In some implementations, coupling waveguides may transmit light bidirectionally (i.e. transmitting reflections).

FIG. 1B schematically illustrates an example of a photonic crystal structure which is logically three dimensional, comprised of six interconnected photonic crystalline arrays 1111a-f, each of which is two dimensional. In this way, FIG. 1B shows an example of how the connectivity of the photonic crystal structure can be non-planar, even when it is comprised of planar elements. The optical input signal 1200 first illuminates an array 1111a. Light output from array 1111a is coupled by waveguide sets 1130a, 1130b and 1130c to each of arrays 1111b, 1111c and 1111f respectively. Light output from array 1111b is coupled by waveguide sets 1130d and 1130e to arrays 1111d and 1111e respectively. Light output from array 1111c is coupled by waveguide sets 1130f and 1130g to arrays 1111d and 1111e respectively. Light output from array 1111d is coupled by waveguide set 1130h to array 1111f. Light output from array 1111e is coupled by waveguide set 1130i to array 1111f. Light output from array 1111f forms the optical output signal 1400.

A PUF based on a photonic crystal structure of plural dimensionality can be stronger than a PUF based on a one-dimensional photonic crystal structure, since a larger space of possible distinct challenge signals is provided and there is typically a greater complexity and variance of responses to slightly different challenges, reducing the predictability of the responses—making both interpolation between responses from similar challenges, and extrapolation from responses to challenges, less likely to be successful.

Two-dimensional photonic crystal structures, and logically higher-dimensional photonic crystal structures constructed from multiple optically coupled one-dimensional or two-dimensional photonic crystalline components, are particularly suitable for integration into PICs and can be fabricated on a substrate using established techniques such as sputtering and/or lithography.

Like all PUFs, the set of responses produced by the PUF to a corresponding set of all possible challenges is substantially unique. This uniqueness can be provided passively as a result of the limits of manufacturing precision available. Alternatively or additionally, this uniqueness can be provided in a deliberate manner. This can be achieved by the photonic crystal structure comprising one or more structural features introduced to break a translational symmetry defined by one or more crystalline lattices (of one, two or three dimensions) comprised in the photonic crystal structure. In this case, the PUF is arranged such that the optical input signal illuminates the photonic crystal structure from one or more angles configured so that the optical input signal's interaction with the photonic crystal structure to produce the optical output signal comprises interaction with at least one of the one or more structural features. Interaction of the optical input signal with such a structural feature is likely to change the optical output signal relative to a photonic crystal which does not comprise that structural feature. Thus more variation between PUFs is possible, making PUFs manufactured in this way stronger.

The one or more structural features introduced can for example comprise a point defect. Point defects can for example comprise:
inclusions, i.e. additive defects in the photonic crystalline lattice such as interstitial defects (that occupy locations in the lattice which would be vacant in a perfect crystalline lattice);
omissions, i.e. cavities or vacancy defects in the photonic crystalline lattice, where a lattice point which would host a motif in a perfect crystalline lattice is empty;
substitutional defects, i.e. where a location which would host the usual repeating motif in a perfect crystalline lattice is occupied by an alternative such as an altered motif.

Inclusions and substitutional defects can for example be metallic nanoparticles, which strongly scatter light of some frequencies but not others. Point defects can be generated by irradiation of the photonic crystal structure, which creates material damage that acts as scattering points for light. Alternatively or additionally, point defects can be fabricated using lithography, for example using a mask coupled with stochastic control of the electron or optical beam technology which sensitises the active surface of the target material. (The term ‘stochastic’, as used in this document, refers to something having a random, pseudorandom or quasi-random characteristic, for example as the result of its generation comprising the use of a (pseudo)random number generator.) Alternatively or additionally, inclusions can be introduced by stochastic sputtering of material over a regular lattice which has been fabricated (for example) using a mask. Alternatively or additionally, inclusions and omissions can be created by using a mask when depositing a photonic crystal structure on a substrate (i.e. the omissions and/or inclusions are part of the design of the mask). Substitutional defects can for example comprise enlarged or shrunken motifs or motifs selected at random by a computer program, from a library of possible motifs which may include random combinations and variations of existing motifs. Alternatively or additionally, altered motifs can be introduced during fabrication by sputtering additional material in a particular area, or by over or under exposing part of a lithographic process. Point defects can for example be of order 10 nm in size, in order to produce subtle optical variation in the PUF's response, while being large enough to be fabricated using methods such as optical lithography, electron lithography and sputtering.

Alternatively or additionally, the one or more structural features introduced can for example comprise a line defect, such as a fault line created by a relative shift or distortion of a row of a photonic crystalline lattice, relative to adjacent rows, by a non-integer number of periods of the lattice.

Alternatively or additionally, the one or more structural features introduced can for example comprise a photonic crystalline grain boundary. That is, the photonic crystal structure 1110 comprises two or more photonic crystalline grains 1111 in one, two or three dimensions, which can abut one another as shown, or can be distributed throughout the PUF 1100, for example over the surface of a substrate on which the PUF is formed. Each photonic crystalline grain 1111 comprises a single photonic crystalline lattice in one, two or three dimensions. Different grains can comprise similar lattices arranged with different orientations. Alternatively or additionally, different grains can comprise different lattices, for example formed of different materials, having different motifs or having different lattice repeat periods. Any such plurality of photonic crystalline grains 1111 comprised in the photonic crystal structure 1110 can be optically coupled to one another in any combination and any order to form one or more optical paths for the optical input signal to follow through the PUF. The optical coupling can for example be provided via waveguides or via evanescent coupling of optical modes, e.g. using an intermediate layer between two layers of photonic crystalline material. Alternatively or additionally, scattering structures can be employed to provide stronger optical coupling, for example a three-dimensional structure arranged to refract, reflect or otherwise scatter light in a particular direction.

Alternatively or additionally, the one or more structural features introduced can for example comprise amorphous regions separating photonic crystalline regions in an artificial opal. (An opal comprises a quasi-crystalline structure, consisting of periodic regions joined together by amorphous regions as opposed to distinct grain boundaries.) Artificial opals can for example be created using regular spheres of an optically active material, such as silica, which are assembled into a quasi-crystalline structure, for example using agitation of the spheres in a container followed by settlement, and then held in place using a binding agent. Alternatively, this process can be simulated using a computer, e.g. by a randomised dynamic simulation of relaxation of the position of mobile spheres settling under gravity in a container, for example using a simulated annealing algorithm, or an annealing algorithm run on a quantum annealer. The result of such a simulation can then be used to create a mask for fabricating the artificial opal.

Alternatively or additionally, the one or more structural features introduced can for example comprise bulk defects such as pores, cracks, larger scale inclusions (e.g. a smaller crystalline structure or other material such as a gas or liquid bubble trapped within the photonic crystalline lattice) and voids (i.e. clusters of vacancy defects). For example, holes could be drilled in the photonic crystal structure, e.g. using lasers or ion beams, and optionally filled with another material, e.g. an optically active material.

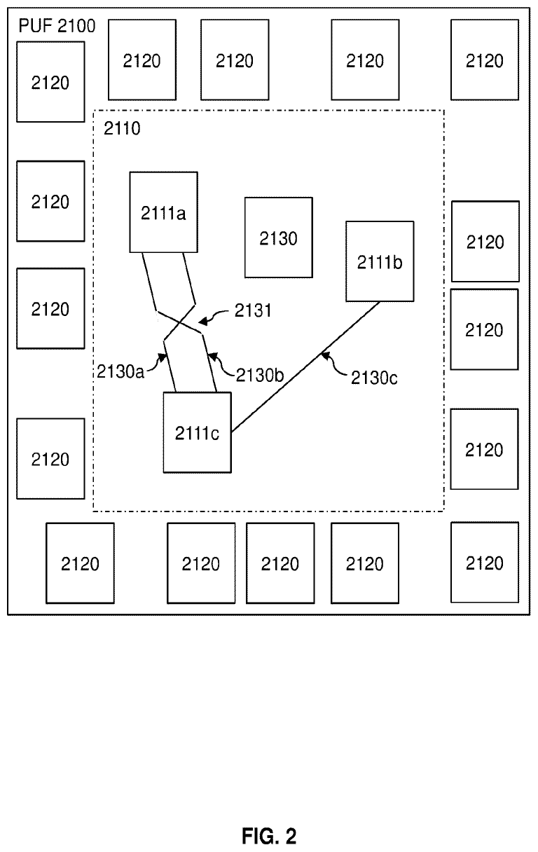

The photonic crystal structure can be arranged with respect to other functional components of the PUF such that any attempt to separate the photonic crystal structure from the PUF would irreversibly destroy the PUF, making the PUF less prone to both tampering and to analysis which could allow a clone of it to be manufactured or modelled. For example, the PUF can comprise one or more functional components such as optical sources, optical filters, optical detectors, delay lines/loops or waveguides. As schematically illustrated in FIG. 2, the photonic crystal structure 2110 can be positioned within a perimeter formed by the one or more such functional components (which may thus be referred to as ‘functional perimeter components’ 2120). Alternatively or additionally, if the photonic crystal structure 2110 comprises multiple spatially separated parts 2111a, 2111b, 2111c, such as multiple photonic crystalline grains or multiple groups of photonic crystalline grains, then one or more such functional components can be positioned between two or more of the plurality of photonic crystalline grains (and may thus be referred to as ‘functional intervening components’ 2130). Such functional intervening components 2130 can optically couple the plurality of photonic crystalline grains together, for example if they are waveguides 2130a, 2130b, 2130c, to form one or more optical paths for the optical input signal to follow through the PUF 2100. Such waveguides 2130a, 2130b can be directly optically coupled to one another, for example by being brought into proximity in an ‘hourglass’ configuration wherein leakage of optical modes at the bends creates mixing of optical states, as illustrated at 2131.

The PUF can comprise a plurality of optical paths into which the optical input signal is input, and which converge to produce the optical output signal. If these paths are of different optical path lengths, then the optical output signal is produced as a superposition, which can exhibit interference patterns when the optical input signal is coherent light or is the sum of multiple coherent light signals, which may be at different wavelengths. Varying the numbers, optical path lengths and optical components present along such optical paths between different PUFs allow for increased variability between PUFs, and thus stronger PUFs. Such optical paths can be clearly defined, for example using waveguides, and/or can arise as a result of dispersion of the optical input signal, for example by an artificial opal, splitter or beam dilater.

The PUF can comprise a component configured to be physically modified in response to all or part of the challenge signal, or an auxiliary signal associated with the challenge signal, for example received within a predetermined time window preceding, following or around the challenge signal, either on the same or a different communication channel. If the physical modification is configured such that the optical output depends thereon, for example by modifying one or both of the optical input signal and optical input signal's interaction with the photonic crystal structure, then the use of such a component can increase the challenge-response space of the PUF, thereby increasing its strength. Any one or more of optical switches, polarisation controllers or modulators, phase or frequency modulators, piezo-electric elements, electro-optic elements, micromechanical elements configured to move part of the PUF and/or photonic crystal, thermal heating elements, and metallic interdigitated fingers (which can be excited by microwaves to produce a surface acoustic wave) could for example be used for this purpose. As one example, the PUF can comprise multiple optical inputs and/or multiple optical outputs and one or more switches can be provided to select between them for illumination of the photonic crystal structure by the optical input signal and/or detection of the optical output signal, in dependence on the challenge or auxiliary signal, such that the one or more optical paths taken through the photonic crystal structure can be varied. Alternatively or additionally, where the photonic crystal structure comprises multiple spatially separated portions, a micromechanical switching element or other actuator could be used together with waveguides to vary the optical paths between those portions. As another example, a piezo-electric element could be used to deform the photonic crystal structure, or the entire PUF. Where the photonic crystal structure comprises multiple layers, those layers can for example be moveable with respect to one other, e.g. using micro-mechanical piezo-electric mountings. Such relative movements could for example comprise one or more of sliding, rotation about an axis perpendicular to a layer's plane and rotation about an axis in a layer's plane (such that layers become more or less parallel to one another). These relative movements of layers can create optical effects akin to the iridescence displayed by some bird feathers. A further example of a physically modifiable component is an electro-optically active element, which can be used to induce a phase change in the optical signal as it interacts with the PUF. Forming the PUF on a lithium niobate substrate for example permits both deformation and phase change variation, since lithium niobate exhibits both piezo-electric and electro-optic characteristics. The challenge signal and/or auxiliary signal can for example be electrical or optical, with electro-optic conversion being provided to interface with the physically modifiable component if required.

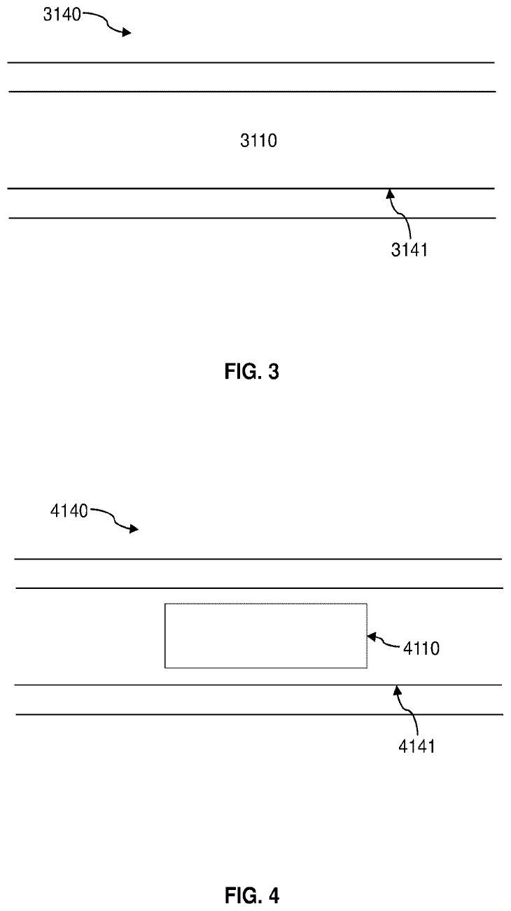

One form of PUF particularly suited to use in optical fibre networks is an optical fibre PUF. Accordingly, the PUF described herein can further comprise an optical fibre in which the photonic crystal structure is located. As schematically illustrated in FIG. 3, in the case of a solid core optical fibre 3140, the photonic crystal structure 3110 can be inscribed in the core 3141, for example by using laser etching. As schematically illustrated in FIG. 4, in the case of a hollow core optical fibre 4140, the photonic crystal structure 4110 can be contained in the core 4141.

There is limited space in the transverse dimension of an optical fibre core to extend a photonic crystalline lattice on an appropriate scale, with spacing on the same order of the wavelength of the illuminating light. (Typical optical fibre core diameters are 9 μm for solid core single mode fibre, and an order of magnitude larger for hollow core fibre.) However, even within these limits it is possible to create a two-dimensional or three-dimensional lattice structure with at least two to ten repeats in the transverse direction.

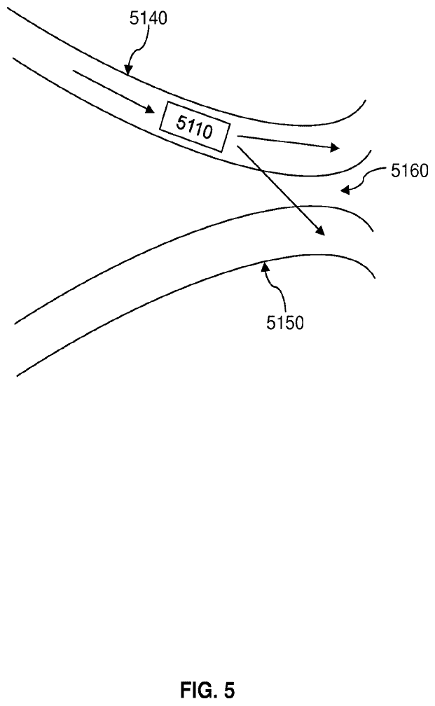

The off-axis components (with respect to the central axis of the optical fibre) of light scattered by such PUFs are strongly attenuated in the fibre, limiting the variation possible in the optical output signal. As schematically illustrated in FIG. 5, one way to increase the possible variation, and thus the PUF strength, is to add an additional optical fibre 5150 optically coupled to the optical fibre 5140 in which the photonic crystal structure 5110 is located, for example by a beam splitter or ‘waist’ 5160 where the two fibres are close enough together for mode coupling between them. The lattice of the photonic crystal structure 5110 can then be angled with respect to the longitudinal axis of the optical fibre 5140 in which it is located such that light scattered off-axis by the photonic crystal structure 5110 is coupled into the additional optical fibre 5150. The optical output signal can then be composed, at least in part, of said light scattered off-axis by the photonic crystal structure 5110 and coupled into the additional optical fibre 5150.

It is noted that this type of PUF structure could usefully be employed even when the photonic crystal structure is one-dimensional. Accordingly, there is proposed a PUF configured to receive a challenge signal and produce a response signal dependent on the challenge signal in response thereto, wherein the PUF comprises:
a first optical fibre;
a second optical fibre; and
a beam splitter configured to optically couple the first and second optical fibres;
   wherein the first optical fibre comprises a photonic crystal structure comprising a lattice angled with respect to a longitudinal axis of the first optical fibre such that light scattered off-axis by the photonic crystal structure is coupled into the second optical fibre, the photonic crystal structure being arranged to:
be illuminated by an optical input signal which is, or is derived from, the challenge signal; and
responsive thereto, produce an optical output signal generated by the optical input signal's interaction with the photonic crystal structure and composed, at least in part, of said light scattered off-axis by the photonic crystal structure and coupled into the second optical fibre, wherein the response signal is, or is derived from, the optical output signal. The first optical fibre can have a solid core in which the photonic crystal structure is inscribed. Alternatively, the first optical fibre can have a hollow core in which the photonic crystal structure is located. The photonic crystal structure can be one-dimensional, two-dimensional, three-dimensional or logically higher-dimensional.

Many of the types of PUFs described above can be comprised in, or formed as part of, PICs. For example, the PUF 1100 of FIG. 1A is shown as comprised in a PIC 1000. In this way, the PUF can be easily incorporated into existing communication networks. In the case of the types of PUF described above wherein the photonic crystal structure is contained in the hollow core of a hollow core optical fibre, if the PUF is comprised in a PIC then the PIC in its entirety can be contained in the hollow core.

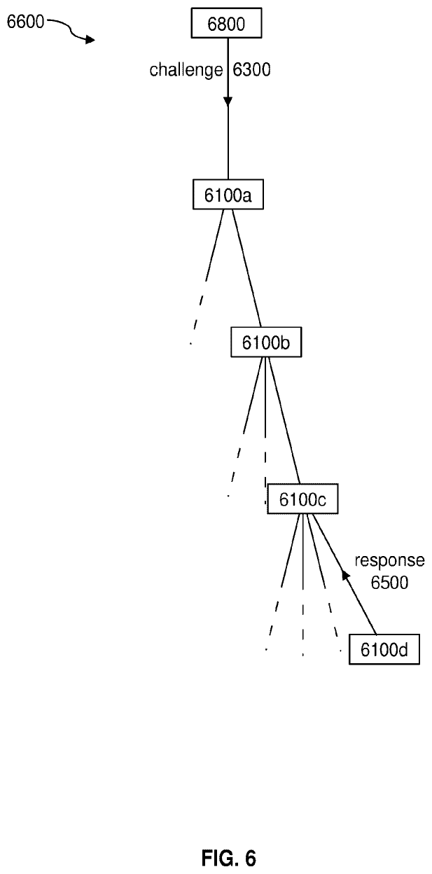

As schematically illustrated in FIG. 6, the types of PUF described herein can be connected in series, with the response signal generated by one PUF 6100 along a route acting as a challenge signal for the next. This arrangement is particularly convenient when the PUFs are all-optical (i.e. not comprising electro-optic conversion of the challenge signal to the optical input signal or the optical output signal to the response signal) and connected via an optical network. The route taken by an optical signal through such an optical network can then be validated by making use of this ‘chained’ arrangement of PUFs. In particular, the response to one or more challenges issued by a challenger 6800 of a chain of PUFs 6100a-6100b-6100c-6100d which are separated along a network, for example joined by coherent optical channels, whether in free space or optical fibre, can be characterised in a similar manner to the response of a single PUF. Corresponding challenges can then be issued, and responses measured, to check that all of the PUFs are present, in the expected order, and without the addition of any unexpected devices which would modify the response. PUFs could be located only on a linear route for which validation is required, or throughout a network 6600 (for example formed in a tree structure, as is generally the case for passive optical networks) so that multiple routes can be validated, and unknown routes can be determined.

The response can be measured at the opposite end of the route to the end the challenge is issued from, and optionally digitised before being checked by the validation authority. Alternatively, as shown in FIG. 6, the response 6500 can be conveyed back to the end of the route the challenge 6300 was issued from to be measured, for example by the challenger 6800. The response can for example be directed back towards the challenger 6800 via reflection or by making use of an optical circulator. The latter approach is generally more secure, particularly if the response is only accepted if received within a predetermined time after issuing the challenge.

As in the case of a single PUF, the response 6500 of a chain of PUFs 6100a-6100b-6100c-6100d to one or more challenges 6300 can be characterised and recorded in advance of validation being required, using the chain of PUFs 6100a-6100b-6100c-6100d itself. This can be performed in situ as part of a setup process when the PUFs 6100a-6100b-6100c-6100d are first installed on the optical network 6600 so that any impact of other network components on the response 6500 is taken into account. Alternatively, if the PUFs 6100a-6100b-6100c-6100d are manufactured in multiples, for example as described below, then a validation authority can hold a clone of the entire chain of PUFs 6100a-6100b-6100c-6100d, issue the same challenge 6300 to both the operative chain 6100a-6100b-6100c-6100d and the clone when validation is required, and compare their responses. Alternatively, if the individual challenge-response matrix of each PUF in the chain 6100a-6100b-6100c-6100d is known (whether from initial testing and recordal or use of corresponding PUFs from sets manufactured in multiple), then the expected response can be calculated based on that knowledge. Any attenuation or dispersion on the optical path connecting the devices which may distort the transmitted signal can be accounted for, for example by allowing a threshold statistical variation in the response to be accepted as a valid response. Such a threshold variation could for example be a fractional Hamming distance of 95%.

When PUFs are connected together by lengthy real-world optical channels, particularly optical fibre channels, there may be some instability in the length of the channels. Phase and polarisation stabilisation can be added along the route to address this, for example between each PUF in the chain 6100a-6100b-6100c-6100d. Fibre stretchers in a control loop could be used for this purpose. On-silica technologies, for example using piezo-electric modulation of waveguide length, could also be used for this purpose, and even integrated with each PUF into a PIC.

Any type of optical PUF can be used to form chains for such optical networks and validation methods, not just the types described herein. Distributed photonic crystal structure based PUF chains are particularly suitable due to their phase and frequency sensitivity. Optical fibre PUFs are particularly convenient for integration into optical fibre networks. On-PIC PUFs are particularly convenient for integration with on-silica stabilisation apparatus.

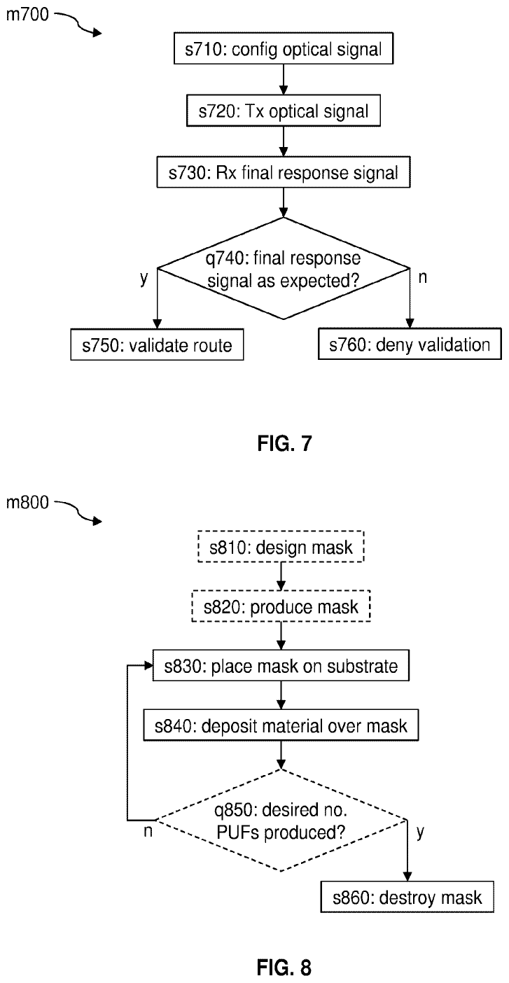

FIG. 7 is a flowchart of a method m700 of validating the route taken by an optical signal through the optical network 6600 of FIG. 6. At step s710 an optical signal is configured to comprise an initial challenge signal 6300. At step s720 the optical signal is transmitted along the route. Subsequently, a signal comprising the final response signal 6500 is received at step s730. Finally, at query q740 it is determined whether the final response signal corresponds to one or both of: i) the initial challenge signal in a stored CRP list; and ii) a final response signal issued by a clone of the route in response to the initial challenge signal being transmitted thereon. If so, the route is validated at step s750 and if not, validation is denied at step s760.

As alluded to above, the PUFs described herein can be manufactured using masks, for example per a method m800 shown in the flow chart of FIG. 8 by placing a mask on a substrate at step s830 then depositing material over the mask at step s840. The mask can then be destroyed at step s860 to ensure no copies of the PUF can be manufactured maliciously at a later time. The mask can define a stochastic pattern to increase uniqueness, and thus strength, of the PUF. Such a mask could for example be designed at step s810 using a lattice generator algorithm which takes one or more stochastic parameters as input. It can for example be produced at step s820 by 3D printing, or by laser cutting of a sheet or film (e.g. a metallic sheet).

PUFs can be produced in multiple at the time of manufacture, so that each party holding one of the resulting PUF clones can authenticate any of the others using their own PUF. This obviates the need to map the challenge-response matrix of the PUF in advance of providing it to the intended holder. Physical security of the PUFs themselves is then sufficient; there is no need to consider how to keep a record of the challenge-response matrix secure, for example from cyber-attacks if stored electronically.

PUFs can be produced in multiple for example by using the same mask on multiple substrates before destroying it as shown by the loop from query q850 back to step s830 in FIG. 8, which continues until the desired number of PUFs are found to have been produced at query q850.

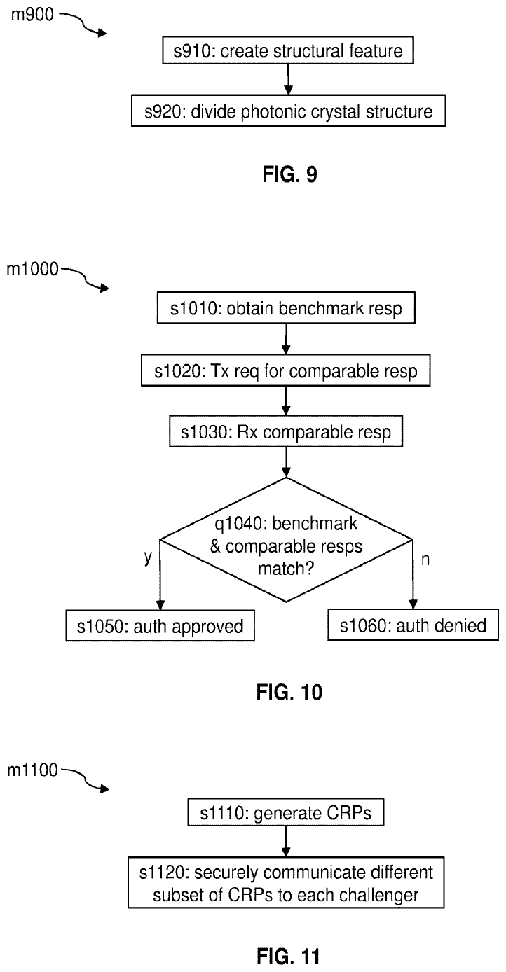

Alternatively, a PUF can be produced with sufficient thickness that it can be sliced, for example using a dicing saw, in such a way as to transect any structural features which result in its unique challenge-response matrix, to form multiple PUFs all having substantially the same challenge-response matrix, for example as explained in applicant's co-pending Patent Cooperation Treaty application number EP2021/080185 ‘Physical Unclonable Functions’, filed 29^{th} Oct. 2021 and claiming priority to UK patent application number 2017392.8, filed 3^{rd} Nov. 2020, which is hereby incorporated by reference. FIG. 9 shows a flowchart of such a method m900 wherein the structural feature is created at step s910, then the photonic crystal structure is divided so as to transect the structural feature at step s920.

To reduce the risk of unauthorised clones being made by further slicing, the PUFs should be made as thin as possible. The ideal case, from a security point of view, where further splitting of layers is physically impossible, occurs in the limit of lifting films which are one atom thick. (In practice the PUFs may need to be a little thicker to ensure the structural feature remains stable.) An example of such an implementation is lifting films of graphene into which periodic defects, such as Stone Wales defects or defects consisting of missing atoms in the layers of graphene material, have been constructed, for example using focussed ion beam micromachining, milling or drilling.

PUF manufacture via thin film lifting can for example be achieved by forming the PUF on a sacrificial substrate layer then flip or stamp transferring the PUF onto a permanent carrier such as a solid or flexible substrate. It can then optionally be encapsulated. (Encapsulation provides protection and, if done using a material of suitable refractive index, can prevent light leakage.) If PUFs are to be produced in multiple then this can be achieved by forming a stack of alternating layers of PUF and sacrificial substrate, then introducing suitably unique structural features to the entire stack at once, for example by drilling holes through it. The sacrificial substrate can then be removed to separate the individual PUFs from one another.

Whatever their method of manufacture, the PUFs produced in multiple may not be perfect clones of one another, so some small margin of error may be allowed when comparing their responses to a challenge.

An authentication method m1000 which PUF clones, such as any of those described above, or others, can be used for is shown in FIG. 10. The method m1000 comprises, at step s1010, obtaining a benchmark response to a common challenge using one of the PUFs known to be held by a trusted authority and, at step s1020, sending a request for a comparable response to a party claiming to hold another of the PUF clones. When a response is received at step s1030 it can be compared to the benchmark response in order to determine whether they match at query q1040. If so, the party claiming to hold the further PUF clone is authenticated at step s1050. If not, authentication is denied at step s1060. This method m1000 can be carried out by the trusted authority itself, by a third party in communication with it, or with some steps performed by the trusted authority and others performed by the third party. For example, the third party may relay the received response to the trusted authority for comparison with the benchmark response, so that the benchmark response never has to be revealed by the trusted authority. The received response could for example be secured, e.g. by encryption with a key known only to those who hold PUF clones, so that no other party can deduce challenge-response pairs (CRPs).

An alternative authentication method m1100, suitable for use when PUFs such as any of the types described above, or others, are produced singly (i.e. no clones are produced) is shown in the flowchart of FIG. 11. The method m1100 comprises, at step s1110, initially using the PUF to generate a list of CRPs by recording the response signals produced in response to a plurality of challenge signals. A different subset of the CRPs is then securely communicated to each of a plurality of potential challengers at step s1120. In this way, each potential challenger is provided with the means to confirm that a correspondent is in possession of the PUF, but no individual party other than the party who generated the initial full list of CRPs (usually the PUF manufacturer), and the PUF holder, can fully characterise the PUF. The different subsets of CRPs can be overlapping, for example to enable a group of challengers to share some CRPs with a new group member, in order to initiate them into the group. Alternatively, for increased security the different subsets of CRPs can be non-overlapping.

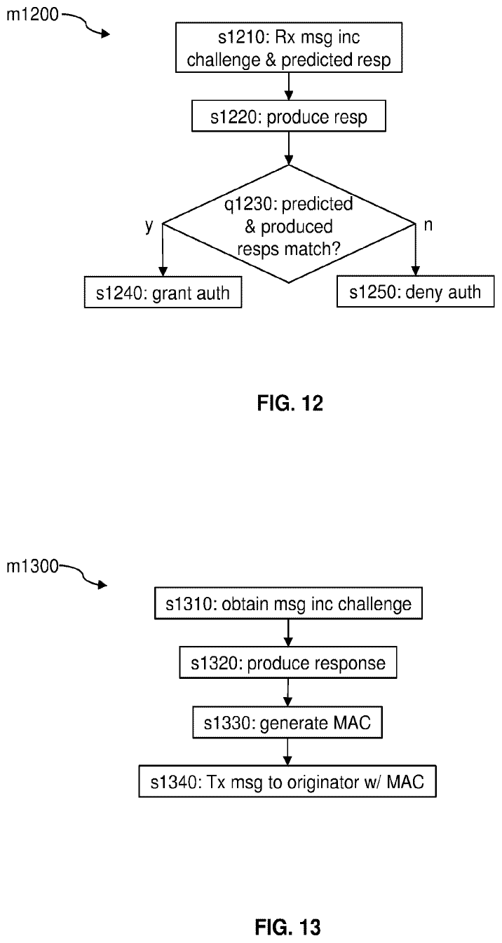

Another authentication method m1200 for use with PUFs such as any of the types described above, or others, is shown in the flowchart of FIG. 12. At step s1210 a PUF holder receives a message comprising a challenge signal together with a predicted response signal. At step s1220 the PUF is used to produce a response signal. At query q1230 it is then determined whether the response signal produced using the PUF matches the predicted response signal. If so, then the originator of the message can be deemed to be authenticated at step s1240 via knowledge of a CRP (which can be securely held data in the case of a single PUF, or can arise from use of a PUF clone in the case of multiple PUFs). If not, then authentication is denied at step s1250.

Yet another authentication method m1300, which can be used with any of the PUF types described above, or indeed any other PUF, is shown in the flowchart of FIG. 13. A PUF holder obtains a message comprising a challenge signal at step s1310, then produces a response signal using the PUF at step s1320. At step s1330 the PUF holder generates a message authentication code (MAC) based on the response signal. (Protocols for generating MACs, for example involving hashing algorithms, are well known.) The PUF holder can then send the message back to its originator together with the MAC at step s1340 so that the originator can authenticate the PUF holder.

Alternatively, the MAC can be used as a shared secret, so that the PUF holder can send further messages which are linked to the MAC, for example by using this as the cryptographic nonce in Wegman Carter hash generated MAC.

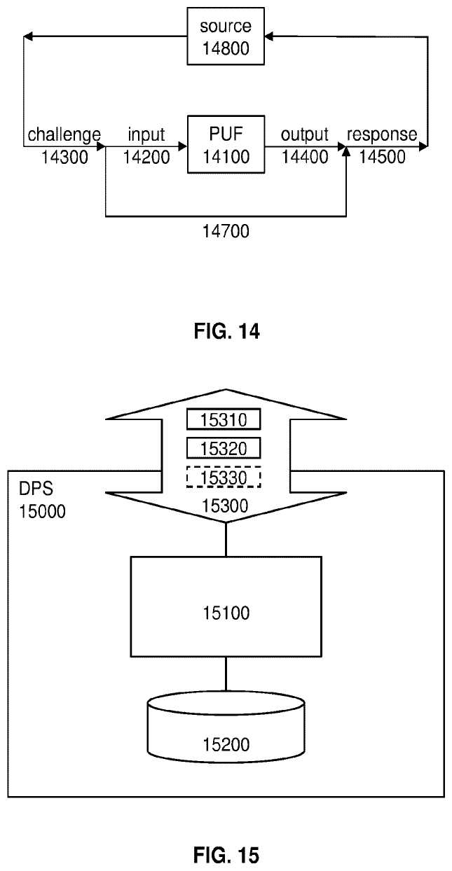

As schematically illustrated in FIG. 14, in implementations in which the response signal 14500 is optical, the message can be modulated onto a classical coherent light communications channel and then a fraction (e.g. 10%) of the modulated classical coherent light can be directed through the PUF 14100 (e.g. via a beamsplitter). Meanwhile, the remainder of the light can be delayed, for example using an optical delay line 14700, by a time corresponding to, or longer than, the time taken for the optical input signal 14200 to traverse the PUF. The optical output signal 14400 can then be combined with the delayed message signal before being returned to the message originator 14800 from which the challenge signal 14300 was received. This combination can for example involve overwriting the part of the message that previously carried the challenge signal, or writing the optical output signal into a ‘quiet window’ in the message reserved for the PUF response.

One or both of the messages received by the PUF and returned by the PUF can comprise metadata, for example indicating a part of the message to be used (or which was used) as the challenge signal, and/or where (for example in time, spatial channel and frequency) the response should be/has been generated. Alternatively, such parameters could be fixed rules and constants of the implementation. In some implementations, the response message could be sent on a different channel to the challenge message, for example on a different fibre or fibre core or in free space. This avoids having to time domain multiplex (i.e. timeswitch) the data and the response on the same channel.

In any of the authentication methods described above, the challenge signal can be distinguished from other challenges, at least in part, by one or both of optical phase variation and optical pulse profile.

FIG. 15 schematically illustrates an example data processing system (DPS) 15000 capable of performing any of the methods described above. It comprises a processor 15100 operably coupled to both a memory 15200 and an interface (I/O) 15300.

The memory 15200 can optionally comprise computer program instructions which, when the program is executed by the processor 15100, cause the data processing system 15000 to carry out any of the methods described above. Alternatively or additionally, the interface 15300 can optionally comprise one or both of a physical interface 15310 configured to receive a data carrier having such instructions stored thereon and a receiver 15320 configured to receive a data carrier signal carrying such instructions.

The receiver 15320, when present, can be configured to receive messages. It can comprise one or more wireless receiver modules and/or one or more wired receiver modules. The interface 15300 can optionally comprise a transmitter 15330 configured to transmit messages. The transmitter 15330, when present, can comprise one or more wireless transmitter modules and/or one or more wired transmitter modules.

While optical PUFs are particularly useful for authentication tasks associated with optical communication networks as described above, the types of PUF described herein could also be employed in other contexts. For example, they could be incorporated into bank notes, payment cards, SIM (subscriber identity module) cards, smart cards and/or other types of token. In order to check its identity and authenticity, the token could be placed into a suitable supporting structure such as a guide frame to input the challenge signal and output the response signal. For example, inputting the challenge signal could comprise illuminating one or more light sources in the guide frame so as to optically couple the optical input signal into the PUF's photonic crystal structure (e.g. via one or more waveguides, beam splitters and/or other functional components as described above). One or more light detectors in the guide frame could then be arranged to collect the resulting optical output signal. The illumination and detection could occur at edges of the token, with the optical signal propagating principally in-plane. Alternatively or additionally, a surface of the token could be illuminated and light reflected and/or transmitted by that surface could be detected.

### Interpretation Notes

Embodiments of the invention will be apparent to those skilled in the art from consideration of the specification. It is intended that the specification be considered as exemplary only.

Where this application lists one or more method steps, the presence of precursor, follow-on and intervening method steps is not excluded unless such exclusion is explicitly indicated. Similarly, where this application lists one or more components of a device or system, the presence of additional components, whether separate or intervening, is not excluded unless such exclusion is explicitly indicated. In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The scope of the present invention includes any novel features or combination of features disclosed herein. The applicant hereby gives notice that new claims may be formulated to such features or combination of features during prosecution of this application or of any further applications derived therefrom. In particular, with reference to the appended claims, features from dependent claims may be combined with those of the independent claims and features from respective independent claims may be combined in any appropriate manner and not merely in the specific combinations enumerated in the claims.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. Such a computer program may be embodied as source code or undergo compilation for implementation on a processing device, apparatus or system or may be embodied as object code, for example.

Such a computer program may be encoded as executable instructions embodied in a carrier medium, non-transitory computer-readable storage device and/or a memory device in machine or device readable form, for example in volatile memory, non-volatile memory, solid-state memory, magnetic memory such as disk or tape, optically or magneto-optically readable memory such as magnetic tape, compact disk (CD), digital versatile disk (DVD) or other media that are capable of storing code and/or data. Such a computer program may alternatively or additionally be supplied from a remote source embodied in a communications medium such as an electronic signal, radio frequency carrier wave or optical carrier wave. Such carrier media are also envisaged as aspects of the present invention.

Such instructions, when executed by a processor (or one or more computers, processors, and/or other devices) may cause the processor (the one or more computers, processors, and/or other devices) to perform at least a portion of the methods described herein.

Where a processor is referred to herein, this is to be understood to refer to a single processor or multiple processors operably connected to one another. Similarly, where a memory is referred to herein, this is to be understood to refer to a single memory or multiple memories operably connected to one another.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, smartphones, tablets, network personal computers (PCs), minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

User devices can include, without limitation, static user devices such as PCs and mobile user devices such as smartphones, tablets, laptops and smartwatches.

Receivers and transmitters as described herein may be standalone or may be comprised in transceivers. A communication link as described herein comprises at least one transmitter capable of transmitting data to at least one receiver over one or more wired or wireless communication channels. Wired communication channels can be arranged for electrical or optical transmission. Such a communication link can optionally further comprise one or more relaying transceivers.

User input devices can include, without limitation, microphones, buttons, keypads, touchscreens, touchpads, trackballs, joysticks, mice, gesture control devices and brain control (e.g. electroencephalography, EEG) devices. User output devices can include, without limitation, speakers, buzzers, display screens, projectors, indicator lights, haptic feedback devices and refreshable braille displays. User interface devices can comprise one or more user input devices, one or more user output devices, or both.

1. A physically unclonable function, ‘PUF’, configured to receive a challenge signal and produce a response signal dependent on the challenge signal in response thereto; wherein the PUF comprises a photonic crystal structure of plural dimensionality which is configured to:
be illuminated by an optical input signal which is, or is derived from, the challenge signal; and
responsive thereto, produce an optical output signal dependent on the optical input signal's interaction with the photonic crystal structure, wherein the response signal is, or is derived from, the optical output signal.

2. A photonic integrated circuit, ‘PIC’, comprising the PUF of claim 1.

3. A method of manufacturing the PUF of claim 1, wherein the photonic crystal structure comprises one or more structural features introduced to break a translational symmetry of one or more crystalline lattices comprised in the photonic crystal structure, the PUF being arranged such that the optical input signal illuminates the photonic crystal structure from one or more angles configured so that the optical input signal's interaction with the photonic crystal structure to produce the optical output signal comprises interaction with at least one of the one or more structural features, the method comprising creating the one or more structural features; the method comprising:
placing a mask on a substrate;
depositing material over the mask; and
destroying the mask;
wherein creating the one or more structural features optionally comprises sputtering a stochastic pattern onto the photonic crystal structure, the mask optionally defining the stochastic pattern;
the method optionally further comprising designing the mask using a lattice generator algorithm which takes one or more stochastic parameters as input.

4. A PUF manufactured according to the method of claim 3.

5. A method of producing a plurality of substantially identical PUFs by performing the method of claim 3, wherein the steps of placing the mask on a substrate and depositing material over the mask are repeated for a plurality of substrates to produce a corresponding plurality of substantially identical PUFs before the step of destroying the mask is performed.

6. A method of producing a plurality of substantially identical PUFs, each of the plurality of substantially identical PUFs being a PUF according to claim 1 wherein the photonic crystal structure comprises one or more structural features introduced to break a translational symmetry of one or more crystalline lattices comprised in the photonic crystal structure, the PUF being arranged such that the optical input signal illuminates the photonic crystal structure from one or more angles configured so that the optical input signal's interaction with the photonic crystal structure to produce the optical output signal comprises interaction with at least one of the one or more structural features, the method comprising creating said at least one of the one or more structural features, then dividing the photonic crystal structure to transect said at least one of the one or more structural features.

7. An authentication system comprising the plurality of substantially identical PUFs manufactured according to the method of claim 5.

8. An authentication method using the authentication system of claim 7, the method comprising:
obtaining a benchmark response to a common challenge using a PUF of the plurality of substantially identical PUFs known to be held by a trusted authority;
sending a request for a comparable response to a party claiming to hold a further PUF of the plurality of substantially identical PUFs;
receiving the comparable response; and
determining whether the party claiming to hold the further PUF is authenticated based on a comparison between the benchmark response and the comparable response.

9. A method of using the PUF of claim 1, the method comprising:
receiving the challenge signal; and
producing the response signal.

10. An authentication method comprising:
generating a list of challenge-response pairs, ‘CRPs’, by performing the method of claim 9 repeatedly using different challenge signals and recording the corresponding response signals; and
securely communicating a different subset of the CRPs to each of a plurality of challengers so that each challenger of the plurality can confirm that a correspondent is in possession of the PUF by transmitting a challenge signal selected from their subset of the CRPs to the correspondent and confirming that a response signal received from the correspondent matches the response signal corresponding to the selected challenge signal.

11. An authentication method comprising:
receiving a message comprising a challenge signal and a predicted response signal;
performing the method of claim 9; and
determining whether an originator of the message is authenticated based on a comparison between the response signal produced and the predicted response signal.

12. A data processing system configured to perform the method of claim 8.

13. A computer program comprising instructions which, when the program is executed by a computer, cause the computer to carry out the method of claim 8.

14. A computer-readable data carrier having stored thereon the computer program of claim 13.

15. A data carrier signal carrying the computer program of claim 13.
